(19) United States
(12) Patent Application Publication
(10) Pub. No.: US 2001/0027941 A1
(43) Pub. Date: Oct. 11, 2001

(54) Filter element

(75) Inventor: Wolfgang Assmann, Kraichtal (DE)

Correspondence Address: LAW OFFICE OF BARRY R LIPSITZ, 755 MAIN STREET, MONROE, CT, 06468, US

(73) Assignee: ARGO GmbH fur Fluidtechnik, Kraichtal (DE)

(21) Appl. No.: 09/794,945

(22) Filed: Feb. 27, 2001

Related U.S. Application Data
(63) Continuation of application No. PCT/EP99/04768, filed on Jul. 7, 1999.

(30) Foreign Application Priority Data
Aug. 28, 1998 (DE) 198 39 190.0

(51) Int. Cl. B01D 27/10

(52) U.S. Cl. 210/130; 210/430

(57) ABSTRACT

In order for a filter element with a casing, having filter material, with an end wall which terminates the casing on an upper side and has a through-passage opening, and with a bypass valve for opening and closing the through-passage opening, the bypass valve having a valve housing which is made of plastics material and accommodates a valve body and a valve spring which loads the valve body in the direction of a valve seat, to be configured such that it can be assembled more easily and produced more cost-effectively, it is proposed that the valve housing comprises a valve guide, and that a separate supporting element is provided, it being possible, for assembly purposes, for the valve body and the valve spring to be introduced into the valve guide and then for the supporting element to be fixed on the valve guide.

The present invention relates to a filter element with a casing, having filter material, for filtering a fluid, with an end wall which terminates the casing on an upper side and has a through-passage opening, with a bypass valve for opening and closing the through-passage opening, the bypass valve having a valve housing which is made of plastics material, comprises a valve guide and accommodates a valve body and a valve spring which loads the valve body in the direction of a valve seat, and with a separate supporting element, it being possible, for assembly purposes, for the valve body and the valve spring to be introduced into the valve guide and then for the supporting element to be fixed on the valve guide.

Such filter elements are used, for example, for filtering mineral oils in hydraulic systems. As the period of operation increases, contaminants are deposited in the filter material, so that the flow resistance of the latter is increased. In order to avoid the situation where, with the filter material blocked, no more fluid can flow through and the fluid supply, for example, to the hydraulic system or an internal combustion engine is interrupted, a bypass valve is provided on the filter element, this valve allowing a flow connection through the filter element without the fluid being filtered if the filter material, on account of contaminants, has a high flow resistance and a relatively high pressure difference thus builds up at the filter material in the flow direction. In the presence of a fixed pressure difference, the bypass valve releases the through-passage opening provided in the end wall, so that the fluid can bypass the filter material and flow through the through-passage opening.

The bypass valve is usually configured as a spring-loaded nonreturn valve with a valve body which is disposed in a valve housing, the valve housing additionally accommodating a valve spring which loads the valve body in the direction of a valve seat. In many cases, the valve housing is produced from metal and, during the assembly of the filter element, is fixed by spot welding on the end wall, which is likewise produced from metal.

Filter elements in the case of which the valve housing is produced from plastics material are also known. If, on account of a filter-material flow resistance forming, there is a high pressure difference between the clean side and the contaminated side of the filter element, the valve body becomes detached from the valve seat, so that the fluid can flow axially into the valve housing through the through-passage opening and, via laterally disposed outflow openings, the fluid can then flow out of the plastics-material valve housing of the bypass valve. The size of the outflow openings is selected there such that, when the bypass valve is assembled, these openings allow access into the interior of the valve housing, so that the valve spring and the valve body can be inserted laterally into the valve housing through the outflow openings. However, this involves a not inconsiderable amount of assembly outlay and correspondingly high production costs.

German Offenlegungsschrift DE 195 46 440 A1 discloses a filter element of the type mentioned in the introduction. This filter element is distinguished, in particular, in that the valve housing, which is produced from plastics material, comprises a valve guide for guiding the valve body and a separate supporting element is provided for supporting the valve spring. It is possible here, for assembly purposes, for the valve body and the valve spring to be introduced into the valve guide and then for the supporting element to be fixed on the valve guide. The supporting element is formed as part of an adjustment device, with the aid of which it is possible to change the spring excursion of the valve spring.

It is an object of the present invention to develop a filter element of the type mentioned in the introduction such that it can be assembled more easily and produced more cost-effectively.

This object is achieved according to the invention, in the case of a filter element of the generic type, in that for introducing the supporting element into, or for positioning the same on, the valve guide, the latter is elastically deformable transversely to its introduction or positioning direction, and in that disposed on the supporting element are hook-like latching protrusions which, when the supporting element is introduced into, or positioned on, the valve guide, snap into corresponding latching mounts and arrest the valve guide transversely to the introduction or positioning direction.

In the case of the filter element according to the invention, use is thus made of a valve housing which is produced from plastics material and has a valve guide, and of a separate supporting element which is preferably likewise produced from plastics material. During the assembly of the filter element, first of all the valve body and the valve spring can be introduced into the valve guide without hindrance from the supporting element. Then the supporting element can be fixed on the valve guide. This allows, in particular, assembly of the filter element in the axial direction, namely counter to the throughflow direction of the fluid which flows through the through-passage opening during use of the filter element. Such a configuration makes it possible in particular, during the assembly of the filter element, first of all to retain the end wall on a suitable tool mount. It is then possible, in the region of the through-passage opening, for the valve guide to be positioned on the underside of the end wall, which is preferably oriented upward during the assembly process, the valve body and the valve spring then being introduced into the valve guide. Finally, the supporting element is fixed on the valve guide. For further assembling the filter element, the casing, having the filter material, can then be positioned on the underside of the end wall and connected non-releasably to the end wall.

According to the invention, for introducing the supporting element, or for positioning the same, the valve guide is elastically deformable transversely to its introduction or positioning direction. It is thus possible, for introducing the supporting element, or for positioning the same, for the valve guide to be radially widened or narrowed, respectively, in which case, on account of its elasticity, it then resumes its initial state.

According to the invention, latching protrusions are disposed on the supporting element. The latching protrusions and associated latching mounts form, for example, undercuts, preferably with abutment surfaces aligned obliquely in relation to the spreading-out direction of the valve guide. This means that although, for introducing the supporting element, or for positioning the same, the valve guide can be spread out or narrowed, respectively, transversely to the introduction or positioning direction, renewed spreading out or narrowing of the valve guide, even with a relatively high pressure difference of the fluid, is reliably prevented, on account of the latching protrusions and latching mounts engaging one behind the other, once the supporting element has latched in. The filter element according to the invention is thus distinguished by an easier assembly which can be carried out in a comparatively short time and thus reduces the production costs of the filter element.

The valve guide preferably comprises a guide sleeve retained on the end wall. The supporting element preferably forms a base wall of the guide sleeve, this base wall being disposed approximately parallel to, and at a spacing from, the end wall. It is possible here for an opening to be provided in the base wall. This opening may be shaped, for example, as a slot, so as to allow radial fixing of the supporting element during the valve assembly.

In a preferred embodiment, it is provided that the guide sleeve is configured in the form of a cylinder and, in its lateral surface, preferably has a plurality of outflow openings distributed over its circumference. Such a configuration is distinguished by comparatively low flow resistance since it is not necessary for the fluid to flow round the entire valve body when the bypass valve is open.

In a particularly preferred embodiment of the invention, it is provided that the supporting element can be fixed on the valve guide by means of a latching connection having at least one latching protrusion and a corresponding latching mount. Such a configuration is distinguished by a particularly easy assembly since there is no need for any additional fastening means for fixing the supporting element on the valve guide, which is preferably configured as a guide sleeve.

It may be provided that the supporting element forms an end cap which engages over the free end of the valve guide, this free end being directed away from the end wall. Such an end cap can easily be positioned on the valve guide during the assembly of the filter element.

Alternatively, it may be provided that the supporting element penetrates into the valve guide.

It is advantageous if the valve guide has longitudinal slots which open out into the free end surface of the valve guide. Such longitudinal slots give the valve guide elasticity of shape and allow it to spread out or narrow elastically in order for it to be possible for the supporting element to be introduced into the valve guide or positioned on the valve guide, respectively, with a low level of force being applied.

It may be provided, for example, that disposed on the supporting element are hook-like latching protrusions which, when the supporting element is introduced into, or positioned on, the valve guide, snap into corresponding latching mounts and arrest the valve guide transversely to the introduction direction.

Both the valve guide and preferably also the supporting element are produced from plastics material. In an embodiment which can be produced particularly cost-effectively, it is provided that the end wall is also produced from plastics material. It is particularly advantageous here if the valve guide and the end wall are formed as one part. In such an embodiment, the end wall and the valve guide may form a single-part injection molding, the valve guide following the through-passage opening of the end wall in the throughflow direction.

Following a specific period of operation, it is necessary for the filter element to be drawn out of an associated filter housing again. The filter element is often fitted snugly in the filter housing in order to achieve good sealing, so that strong grip elements are necessary in order for it to be possible for the filter element to be drawn out of the filter housing. In a preferred configuration, it is provided that on its upper side, which is directed away from the valve guide, the end wall carries a grip handle which is formed integrally with it and is adjacent to the upper side in a rest position and can be pivoted into a grip position, in which it is angled away from the upper side. On account of the grip handle and end wall being configured integrally, separate assembly of the grip handle on the end wall can be dispensed with and it is ensured that it is not possible to forget the grip handle during the assembly of the filter element.

In its rest position, the grip handle is particularly preferably aligned obliquely in relation to the upper side of the end wall. This means that a user can easily grip the grip handle and pivot it into its grip position.

When the bypass valve is open, the fluid flows through the through-passage opening and the outflow openings and then comes into contact with the inside of the filter material, which is arranged on the casing of the filter element. This results in not inconsiderable mechanical loading of the filter material. In a preferred embodiment, it is thus provided that disposed on the valve guide, adjacent to the valve seat, is a directing element which is aligned obliquely in relation to a longitudinal axis of the filter element. Such a directing element results in the fluid being deflected, as it flows through the bypass valve, such that it comes into contact with the inside of the filter material obliquely in relation to the longitudinal axis of the filter element. The mechanical loading of the filter material is reduced as a result. The oblique flow guidance brought about by the directing element, moreover, effects a reduction in the pressure loss of the fluid as it flows through the filter element.

It is particularly favorable if the directing element is formed integrally with the valve guide since this means that the filter element can be produced particularly cost-effectively.

The casing of the filter element with the filter material is retained on the end wall. It is advantageous here if, in its end region adjacent to the end wall, the valve guide forms on its outside, at least along a sub-region of its outer circumference, a receiving means for the engagement of a fixing element which fixes the filter material in the filter element. In relation to the longitudinal axis of the filter element, the receiving means forms an undercut in which the fixing element can engage so as to produce a mechanical connection between the fixing element and the guide sleeve which can be subjected to particularly pronounced loading.

The fixing element may comprise, for example, an adhesive layer which engages in the receiving means. This may be made here, for example, of an epoxide resin adhesive or of a polyurethane-based adhesive which connects the filter material of the casing to the end wall and the valve guide in a fluid-tight manner.

The end wall preferably has a laterally drawn-down border which encloses the casing in the region of the bypass valve. The fluid, which usually flows in through a radial bore, subjects the filter material to particularly high mechanical loading. By virtue of the drawn-down border, the bypass valve is enclosed by an annular space into which the filter material can be introduced, the filter material achieving, in the region of the bypass valve, high mechanical stability against the fluid, which usually flows in through a radial bore.

It is clear from the above that the end wall with the integrally formed grip handle and integrally formed valve guide, preferably in the form of a guide sleeve, and preferably with an integrally formed border, may form a single-part injection molding. In addition, it is possible to provide further injection moldings in the form of the valve body and of the supporting element. It is particularly favorable if these injection moldings are produced in a single operation such that the valve body and the supporting element are additionally molded in the form of wings on the end wall with the integrally formed grip handle and integrally formed valve guide. A single-part combination injection molding configured in this way allows particularly cost-effective production and storage and simpler logistics. For the assembly of the filter insert, it is possible for the assembly parts molded on in the form of wings, these assembly parts being the valve body and the supporting element, to be broken off or mechanically separated from the end wall. It is then possible for the valve body, together with a valve spring, to be introduced into the guide sleeve, which is connected integrally to the end wall, and then the supporting element is latched into the guide sleeve.

The following description of a preferred embodiment of the invention serves for a more detailed explanation in conjunction with the drawing, in which:

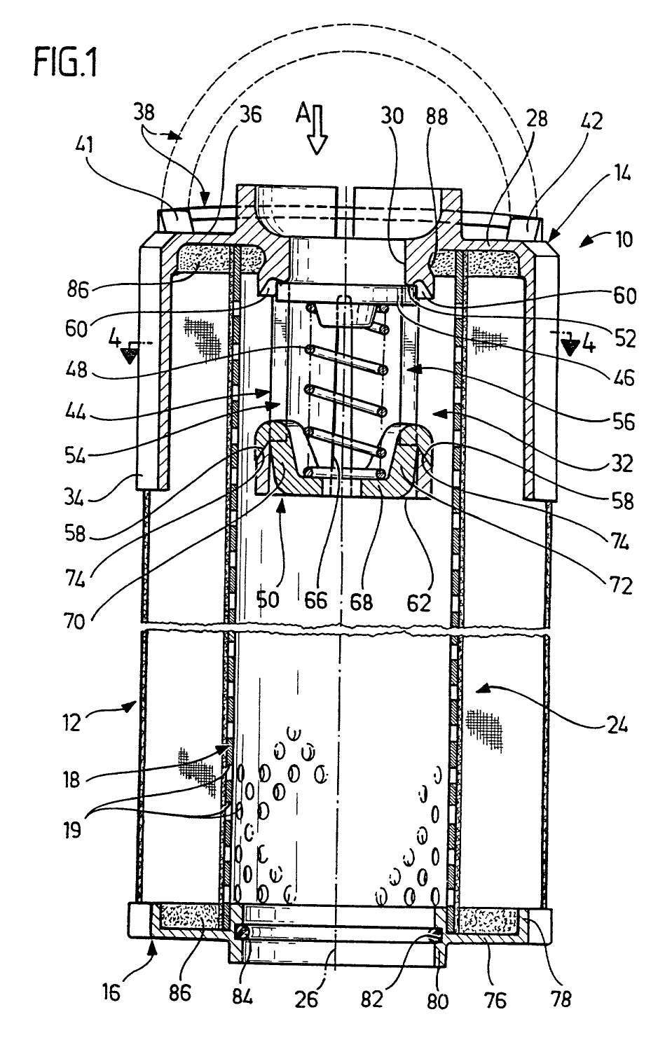

FIG. 1 shows a longitudinal section through a filter element;

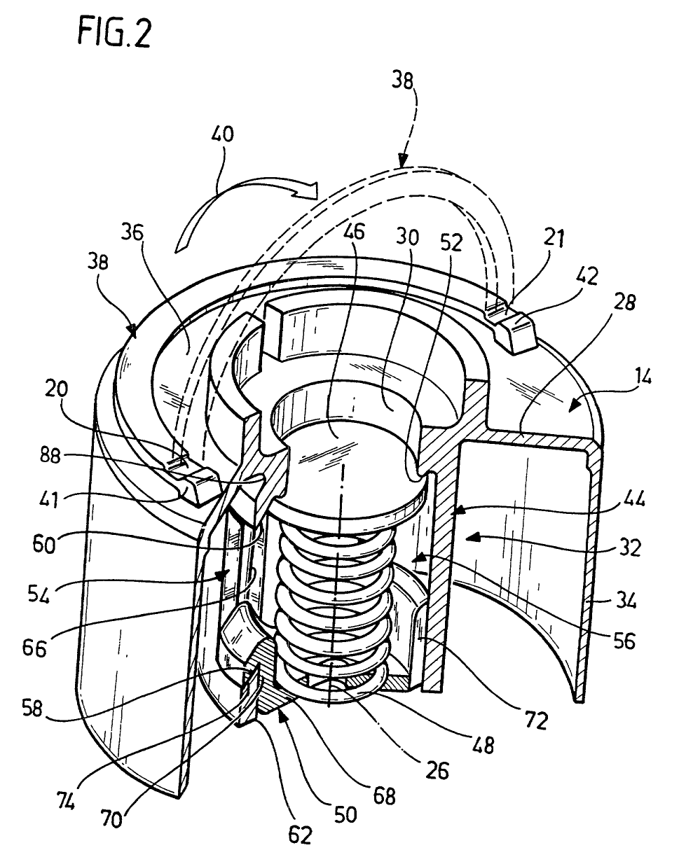

FIG. 2 shows a schematic illustration of an end wall which is used for the filter element according to FIG. 1, is sectioned in the longitudinal direction and has the integrally formed grip handle, integrally formed guide sleeve and laterally drawn-down sleeve-like border;

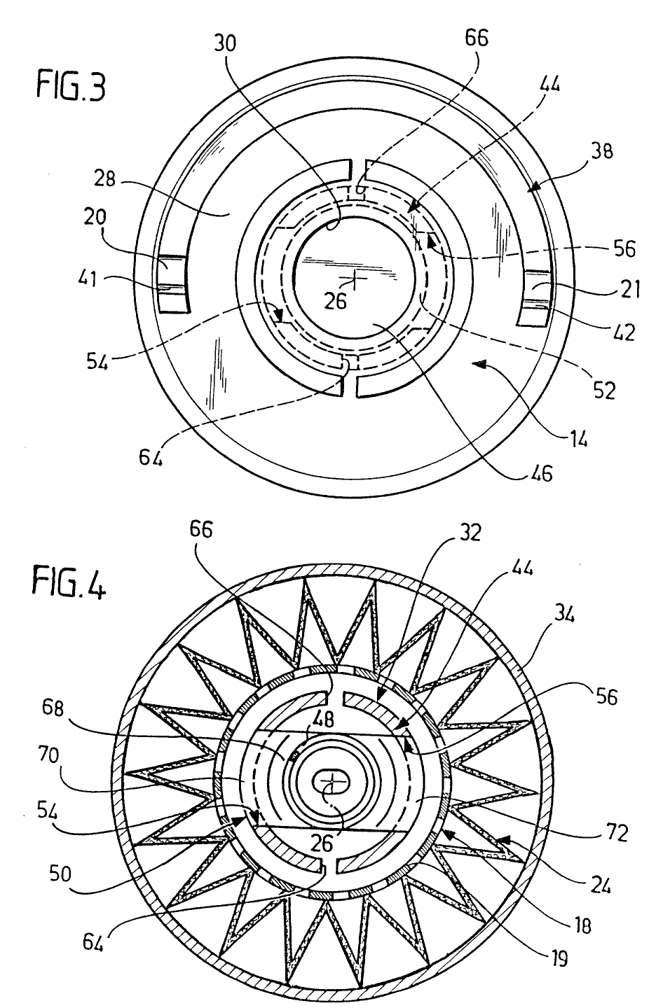

FIG. 3 shows a view of the filter element in the direction of the arrow A in FIG. 1;

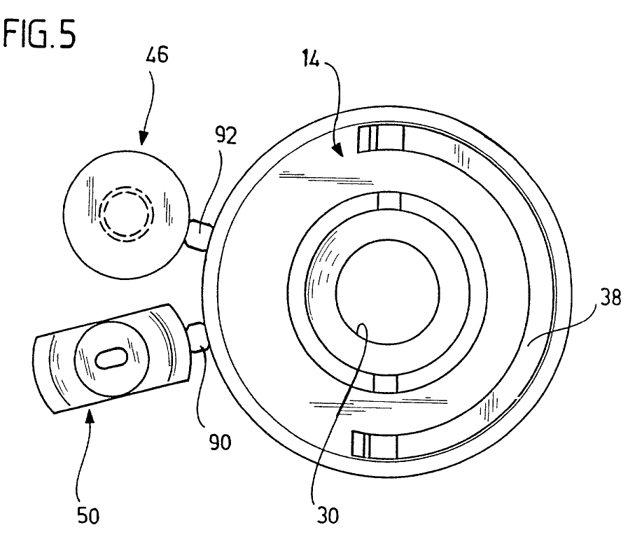

FIG. 4 shows a sectional view along line 4-4 in FIG. 1; and

FIG. 5 shows a plan view of a combination injection molding in the form of the end wall, illustrated in FIG. 2, with molded-on valve disk and molded-on supporting element.

A filter element designated 10 overall is illustrated in FIGS. 1 to 4. This filter element substantially comprises a hollow-cylindrical casing 12, on the end sides of which there are disposed an end wall 14, on the one hand, and an end cap 16, on the other hand.

The casing 12 comprises a supporting tube 18 which is produced from metal or from a plastics material and has numerous throughflow bores 19 passing through it in the radial direction. As can be seen, in particular, from FIG. 4, a substantially hollow-cylindrical filter material in the form of a filter bellows 24, which is coaxial with the supporting tube 18 and has one or more layers, is disposed around the supporting tube 18. This filter bellows 24 is known per se and is thus only schematically illustrated in the drawing. It is folded in star form by folds running parallel to a longitudinal axis 26 of the filter element 10, such that radially outer fold tips and radially inner fold bases follow alternately one after the other along its circumference.

The end wall 14 comprises an annular termination disk 28 with a central circular through-passage opening 30, which is followed in the axial direction of the filter element 10 by a bypass valve 32, which is described in more detail hereinbelow and is disposed within the supporting tube 18, coaxially therewith and at a spacing therefrom. Along its outer circumference, the termination disk 28 has integrally formed on it a border which is drawn down in the direction of the end cap 16, is in the form of a cylindrical sleeve 34 and encloses that end region of the filter bellows 24 which is directed toward the termination disk 28.

On its top side 36, which is directed away from the filter bellows 24, the termination disk 28 has a semicircular grip handle 38 integrally formed on it. This grip handle can be pivoted out of a rest position, which is illustrated by solid lines in FIGS. 1 and 2, into a grip position, which is illustrated by dashed lines in FIGS. 1 and 2, and the pivoting movement is illustrated by the arrow 40 in FIG. 2. At its end regions, the grip handle 38 is connected integrally to the termination disk 28 via webs 41 and 42, while it is disposed with the rest of its ring region, even in its rest position, at a spacing from, and obliquely in relation to, the upper side 36 of the termination disk 28, so that, for the filter maintenance, a user can grip behind it in its rest position and pivot it into its grip position. The pivotability of the grip handle 38 is ensured by film hinges 20 and 21.

The bypass valve 32 comprises a guide sleeve 44 which follows the through-passage opening 30 in the axial direction, is of hollow-cylindrical configuration, is aligned coaxially with the longitudinal axis 26, is connected integrally to the termination disk 28 and accommodates a valve body in the form of a valve disk 46 and a valve spring configured as a helical spring 48. At its free end, which is directed away from the termination disk 28, the guide sleeve 44 carries a valve-spring mount 50 which forms a supporting element supporting the helical spring 48. The helical spring 48 is clamped in between the valve-spring mount 50 and the valve disk 46 and thus subjects the valve disk 46 to a spring force in the direction of the through-passage opening 30.

The internal diameter of the guide sleeve 44 is selected to be larger than the diameter of the through-passage opening 30, thus forming, in the transition region between the through-passage opening 30 and the guide sleeve 44, a radial widening in the form of a step which forms an annular valve seat 52 against which the valve disk 46 comes into abutment on account of the spring loading.

The hollow-cylindrical guide sleeve 44 has, in the circumferential direction, two mutually opposite outflow openings 54 and 56, which extend approximately up to the level of the valve seat 52. The outflow openings 54 and 56 are each of rectangular form with axially running longitudinal sides and upper and lower boundaries running transversely to the longitudinal axis 26, the lower boundary being formed by a sliding surface 58 which is aligned obliquely in relation to the longitudinal axis 26 and is directed toward the termination disk 28, while the upper boundary is formed by a flow-off surface 60 which is directed away from the termination disk 28, is disposed approximately level with the valve seat 52 and is aligned parallel to the sliding surface 58, that is to say likewise obliquely in relation to the longitudinal axis 26.

Formed in the guide sleeve 44, offset by 90° in each case in relation to the outflow openings 54 and 56, are longitudinal slots 64, 66 which extend from the free end surface 62, directed away from the termination disk 28, of the guide sleeve to approximately level with the valve seat 52.

The valve-spring mount 50 comprises a web 68 which is aligned transversely to the longitudinal axis 26, engages through the guide sleeve 44 and, in the region of the outflow openings 54 and 56, has wing-like latching hooks 70 and 72, respectively. The latter engage in the outflow openings 54 and 56 and, at their free ends, have run-on surfaces 74 which are directed toward the end surface 62 of the guide sleeve 44 and correspond to the sliding surfaces 58 at the outflow openings 54 and 56, so that the web 68 can be positioned in surface-area contact with the sliding surfaces 58 by way of the run-on surfaces 74. The run-on surfaces 74 thus form an undercut with the sliding surfaces 58 in each case, so that the latching hooks 70 and 72 engage behind the outflow openings 54 and 56, respectively.

At its end which is directed away from the termination disk 28, the filter bellows 24 carries the end cap 16. The latter comprises an annular end disk 76 which, on its outer border, is provided with an end ring 78 which projects upward in the axial direction, that is to say is directed toward the termination disk 28. On its inner border region, the end disk 56 [sic] carries a retaining ring 80 which is aligned coaxially with the longitudinal axis 26 and the inner wall of which is provided with an annular groove 82 in which an O-ring 84 is disposed.

In the region of its end sides, the filter bellows 24 is connected in a fluid-tight manner, by means of an epoxide resin adhesive 86 or by means of some other, for example polyurethane resin-based, adhesive system, to the termination disk 28, on the one hand, and to the end cap 16, on the other hand. In this case, the adhesive 86 fills an adhesive-receiving means 88 which is formed in the outside of the guide sleeve 44 in the axial direction between the flow-off surface 60 and the underside of the termination disk 28, this underside being directed toward the filter bellows 24. In relation to the longitudinal axis 26, this adhesive-receiving means forms an undercut, which gives the connection between the filter bellows 24 and the termination disk 28 by means of the adhesive 86 high mechanical stability in the axial direction. This ensures that, when the filter element 10 is drawn out of a filter housing known per se (not illustrated in the drawing), the filter bellows 24 cannot become detached from the termination disk 28.

As is clear, in particular, from FIG. 2, the end wall 14 is configured as a single-part plastics injection molding with the termination disk 28, the cylindrical sleeve 34 and the grip handle 38 and the guide sleeve 44. For assembly of the filter element, the end wall 14 can be fixed radially in a suitable tool mount. Then the valve disk 46 and the helical spring 48 can be introduced into the guide sleeve 44 in the axial direction. Thereupon, the valve-spring mount 50 can be introduced into the guide sleeve 44, likewise in the axial direction, counter to the spring force of the helical spring 48. For this purpose, the guide sleeve 44 is elastically deformable transversely to the longitudinal axis 26, and thus transversely to the introduction direction of the valve-spring mount 50, the longitudinal slots 64 and 66 being formed in the guide sleeve 44 in order to achieve the elastic deformability. Upon introduction, the guide sleeve 44 is first of all elastically deformed transversely to the longitudinal axis 26 until the latching hooks 70 and 72 latch into the outflow openings 54 and 56, respectively, and engage behind the sliding surfaces 58 in the process.

For further assembling the filter element, the underside of the termination disk 28 is covered over with an adhesive and then the filter bellows 24 is introduced into the annular space between the bypass valve 32 and the sleeve 34, and the adhesive 86 is set. Finally, the end cap 16 is positioned on the filter bellows 24 once an adhesive has likewise been introduced into the end cap, and this adhesive then hardens.

The assembly of the filter element 10 is thus very easy and, on account of the plastics-material end wall 14 being configured as a single piece, the filter element can be produced very cost-effectively.

The production of the end wall 14, in turn, can take place cost-effectively together with the production of the valve disk 46 and of the valve-disk mount 50 such that the three assembly parts are produced in the form of a single-part combination injection molding. Such a combination injection molding is illustrated in FIG. 5. In this case, the valve disk 46 and the valve-disk mount 50 are molded on the outside of the end wall via narrow plastic bridges 90 and 92. For assembly, the valve disk 46 and the valve-disk mount 50 can easily be broken off or mechanically separated from the end wall 14, whereas they are connected integrally to the end wall 14 for storage and transportation purposes.

During operation, a fluid which is to be filtered flows in a conventional manner against the filter element 10, on the outside of the filter bellows 24. This fluid flows radially through the filter bellows 24 and the supporting tube 18 and can then flow axially out of the filter element 10 through a central outlet opening in the end cap 16. As the period of operation of the filter element 10 increases, more and more contaminants are deposited in the filter bellows 24, so that the fluid is subjected to increased flow resistance as it flows through. This results in a greater pressure difference forming on the filter bellows 24 in the flow direction. If the filter element is fully clogged up with contaminants, this means that virtually no fluid can flow through the filter bellows 24 any longer. In order to prevent the situation where, on account of the thus interrupted flow connection, no more mineral oil can be fed, for example, to an internal combustion engine, the bypass valve 32 is provided. This is acted upon by the drop in pressure prevailing in the filter bellows 24 in the flow direction and, when a specific pressure level is reached, the bypass valve 32 opens by virtue of the valve disk 46 being raised away from the valve seat 52 counter to the spring force of the helical spring 48. The fluid can then flow through the through-passage opening 30, although, when it comes into contact with the valve disk 46, it is first of all deflected in the radial direction. The fluid then comes into contact with the flow-off surface 60, which is aligned obliquely in relation to the longitudinal axis 26, and is thus aligned obliquely in relation to the longitudinal axis 26. The flow-off surface 60 thus forms a directing element for the fluid flowing through the through-passage openings 30, the directing element preventing the fluid from being able to flow substantially perpendicularly through the openings 19 of the supporting tube 18. The deflection of the fluid by means of the upper flow-off surface 60 thus reduces the mechanical loading of the filter bellows 24. In addition, the filter bellows 24 is protected in the region of the bypass valve 32, on account of the sleeve 34 enclosing the filter bellows 24 in this region, against being destroyed by the fluid, which usually flows in via a radial bore. The filter element 10 is thus distinguished by particularly good assemblability, favorable production costs and high mechanical stability.

1. Filter element with a casing (12), having a filter material (24), for filtering a fluid, with an end wall (14) which terminates the casing (12) on an upper side and has a through-passage opening (30), with a bypass valve (32) for opening and closing the through-passage opening, the bypass valve (32) having a valve housing which is made of plastics material, comprises a valve guide (44) and accommodates a valve body (46) and a valve spring (48) which loads the valve body (46) in the direction of a valve seat (52), and with a separate supporting element (50), it being possible, for assembly purposes, for the valve body (46) and the valve spring (48) to be introduced into the valve guide (44) and then for the supporting element (50) to be fixed on the valve guide (44), characterized in that for introducing the supporting element (50) into, or for positioning the same on, the valve guide (44), the latter is elastically deformable transversely to its introduction or positioning direction, and in that disposed on the supporting element (50) are hook-like latching protrusions (70, 72) which, when the supporting element (50) is introduced into, or positioned on, the valve guide (44), snap into corresponding latching mounts (54, 56) and arrest the valve guide (44) transversely to the introduction or positioning direction.

2. Filter element according to claim 1, characterized in that the valve guide comprises a guide sleeve (44) retained on the end wall (14).

3. Filter element according to claim 2, characterized in that the supporting element forms a base wall (68) of the guide sleeve (44), this base wall being disposed approximately parallel to, and at a spacing from, the end wall (14).

4. Filter element according to one of the preceding claims, characterized in that the supporting element (50) can be fixed on the valve guide by means of a latching connection having at least one latching protrusion (70, 72) and a corresponding latching mount (54, 56).

5. Filter element according to one of the preceding claims, characterized in that the supporting element forms an end cap which engages over the free end of the valve guide, this free end being directed away from the end wall.

6. Filter element according to one of the preceding claims, characterized in that the supporting element (50) penetrates into the valve guide (44).

7. Filter element according to one of the preceding claims, characterized in that the valve guide (44) has longitudinal slots (64, 66) which open out into the free end surface (62) of the valve guide (44).

8. Filter element according to one of the preceding claims, characterized in that latching protrusions (70, 72) and latching mounts (54, 56) which engage one behind the other are disposed on the supporting element (50) and on the valve guide (44).

9. Filter element according to one of the preceding claims, characterized in that the end wall (14) is produced from plastics material.

10. Filter element according to one of the preceding claims, characterized in that the valve guide (44) and the end wall (14) are configured as one part.

11. Filter element according to one of the preceding claims, characterized in that on its upper side (36), which is directed away from the valve guide (44), the end wall (14) carries a grip handle (38) which is formed integrally with it and is adjacent to the upper side (36) in a rest position and can be pivoted into a grip position, in which it is angled away from the upper side (36).

12. Filter element according to claim 11, characterized in that, in its rest position, the grip handle (38) is aligned obliquely in relation to the upper side.

13. Filter element according to one of the preceding claims, characterized in that disposed on the valve guide (44), adjacent to the valve seat (52), is a directing element (60) which is aligned obliquely in relation to a longitudinal axis (26) of the filter element (10).

14. Filter element according to claim 13, characterized in that the directing element (60) is formed integrally with the valve guide (44).

15. Filter element according to one of the preceding claims, characterized in that, in its end region adjacent to the end wall (14), the valve guide (44) forms on its outside, at least along a sub-region of its outer circumference, a receiving means (88) for the engagement of a fixing element (86) which fixes the filter material (24) in the filter element (10).

16. Filter element according to claim 15, characterized in that the fixing element comprises an adhesive layer (86) which engages in the receiving means (88).

17. Filter element according to one of the preceding claims, characterized in that the end wall (14) has a laterally drawn-down border (34) which encloses the casing (12) in the region of the bypass valve (32).
